(19) United States
(12) Patent Application Publication
(10) Pub. No.: US 2013/0254299 A1
(43) Pub. Date: Sep. 26, 2013

(54) SENDER FEEDBACK ON EMAIL CORRESPONDENCE

(71) Applicants: Yevgeny Burshtein, Nesher (IL); Zak Mandel, Nesher (IL)

(72) Inventors: Yevgeny Burshtein, Nesher (IL); Zak Mandel, Nesher (IL)

(73) Assignee: International Business Machines Corporation, Armonk, NY (US)

(21) Appl. No.: 13/411,565

(22) Filed: Mar. 26, 2012

(51) Int. Cl. G06F 15/16

(52) U.S. Cl. 709/206

(57) ABSTRACT

Method, system, and computer program product for sender feedback on email correspondence are provided. The method performed at an email client or server includes: activating a feedback service; receiving one or more emails; generating a feedback request to an email sender; receiving a response to the feedback request providing feedback; and handling an email in accordance with the received feedback. The method may also include filtering received emails to determine if a feedback request is to be sent. If the feedback indicates that an email is no longer relevant, the handling step may include deleting or marking the email accordingly.

### BACKGROUND

This invention relates to the field of sender feedback on email correspondence. In particular, the invention relates to sender feedback on out-of-office correspondence.

In modern office environments, people have to deal with an increasing amount of email correspondence. When people are out of office or unavailable for a significant period of time these emails build up very quickly to numbers which are difficult to handle. In many cases, people have to go over hundreds of emails when they return to their office. The most affected groups are managers and other key personnel.

One of the popular solutions to decrease the overload is using an “out-of-office” feature, which is implemented in many email clients or email servers. A user sets this feature whilst absent and a reply email is automatically sent to any email received whilst this feature is activated. The reply email states that the recipient is unavailable and usually gives a return date. This can potentially decrease the number of direct emails and it alerts the sender to the fact that the recipient is not available. However, it does not solve the issue completely, as it still leaves the received emails to be answered on the person's return. In addition, the person continues receiving many emails that were targeted to group emailing lists.

If a sender is unaware that the recipient is unavailable, the content of the email may be invalid or irrelevant. For example, the email may contain an invitation to a meeting during the recipient's absence. Even with an “out-of-office” feature, such emails may be sent, as the sender is not aware of the absence until the email has been sent and an out-of-office reply received.

### BRIEF SUMMARY

According to a first aspect of the present invention there is provided a computer-implemented method for sender feedback on email correspondence performed by a computerized device, comprising: activating a feedback service; receiving notification of one or more emails; generating a feedback request to an email sender; receiving a response to the feedback request providing feedback; and handling an email in accordance with the received feedback.

According to a second aspect of the present invention there is provided a computer program product for sender feedback on email correspondence, the computer program product comprising: a computer readable non-transitory storage medium having computer readable program code embodied therewith, the computer readable program code comprising: computer readable program code configured to: activate a feedback service; receive notification of one or more emails; generate a feedback request to an email sender; receive a response to the feedback request providing feedback; and handle an email in accordance with the received feedback.

According to a third aspect of the present invention there is provided a system for sender feedback on email correspondence provided at an email client or an email server, comprising: a processor; a message receiving component for receiving emails or receiving notification of emails held at another location; a feedback service component including: an activation component for activating a feedback service; a request generating component for generating a feedback request to an email sender; a feedback receiving and processing component for receiving a response to the feedback request providing feedback; and a message handling component for handling an email in accordance with the received feedback.

According to a fourth aspect of the present invention there is provided a method of providing a feedback service for email correspondence to a customer over a network, the service comprising: activating a feedback service; receiving one or more emails; generating a feedback request to an email sender; receiving a response to the feedback request providing feedback; and handling an email in accordance with the received feedback.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a flow diagram of a method in accordance with the present invention;

FIG. 2 is a flow diagram of a first example embodiment of a method in accordance with the present invention;

FIG. 3 is a flow diagram of a second example embodiment of a method in accordance with the present invention;

FIG. 4 is a flow diagram of a further aspect of a method in accordance with the present invention;

FIG. 5 is a block diagram of a system in accordance with the present invention;

FIG. 6 is a block diagram of a computer system in which the present invention may be implemented.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Method, system and computer program product are described which automatically handle emails received from a sender when the recipient was unavailable based on feedback of the relevancy of emails from the sender after being notified of the recipients unavailability.

An email client or email server may be modified to provide the described functionality. On activation, the feature may group emails according to sender and send to each identified sender a feedback request. In one embodiment, the request will contain a list of relevant emails and check boxes, allowing sender to specify still relevant emails and possibly their priority. According to the sender decision, irrelevant emails may be automatically removed from the receiver's inbox.

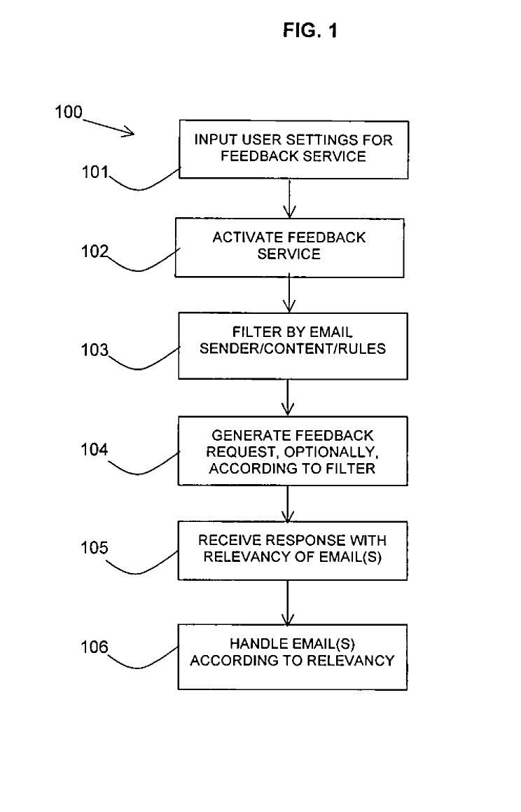

Referring to FIG. 1, a flow diagram 100 shows the described method of a feedback service for emails. As a preliminary step, a user may input 101 user settings for the feedback service. Such setting will be discussed further below but may include personalising a feedback request message, setting rules for sending a feedback request, such as the timing of the request, the senders to which requests are sent or not sent, types of message or message content for which requests are to be sent or not sent, etc.

A feedback service may be activated 102. This may be manually activated by a user, for example, if the user has too many emails built up and wishes to reduce the number, or to prioritize or optimize the presentation of them. For example, the user may have been away from his office without an out-of-office service activated, or may have been busy with a project and ignored incoming emails for a period.

Alternatively, the activation may be automatically triggered. For example, it may be triggered when an out-of-office service is deactivated when the user has been absent for a time, or during an out-of-office service at a given time period, or in response to each email received during an out-of-office service. In another example, the activation may be triggered on user login after a period of absence or after deactivation of an out-of-office service. The activation may also be time-shifted, for example, two days before a user returns to the office. In a further example, the activation may be triggered automatically by a number of unread emails reaching a threshold amount.

Notification of receipt of one or more emails is received. For example, as unread emails in the user's inbox. An email or multiple emails to which the feedback service is to be applied may be filtered 103 based on the sender, the content, or by the rules provided in the user settings.

The filter may be configurable to automatically exclude senders. For example, this exclusion may be based on enterprise hierarchy such that senders in positions of superiority are not sent feedback requests. Other possible examples may include: specific user rules; manual exclusion; exclusion based on history (e.g. a sender identified in the past that he is not willing to provide such feedbacks or sender consistently ignored such feedback requests); or social network relationship (e.g. send only to people who are close to sender, or different messages to different social circles).

The filter may also be configurable to automatically exclude received emails based on history or rules (personal or collaborative). For example, a user may make a decision not to send feedback requests for personal emails received at a work place and may exclude these emails and define the filter accordingly. This decision may be stored and used later as a policy or rule.

The filter may also be configurable to automatically exclude emails based on their content, for example, such as emails with words “Do not reply”.

A feedback request may be generated 104. The feedback request may be combined with a regular back-to-office message or may be sent independently. The user may be presented with a generated request with a generalized wording. The user may be provided with the opportunity to personalize the wording for all senders or for specific groups of senders. This may be done in the user settings, or at the time of sending the request if this is done when the user is present.

A request may be for feedback regarding a single email or for multiple emails from the same sender. The request may be in the form of an email and may include a request description and a brief overview of sent emails. The feedback request may include checkboxes for relevancy or priority of the/or each email message from the sender and, optionally, a scale of priority of an email message. In the request, presentation of the emails on which feedback is requested may be optimized, for example, combining emails of the same correspondence chain, or may be in chronological order.

A feedback request response may be received 105 from the sender including details of the relevancy of the email or emails.

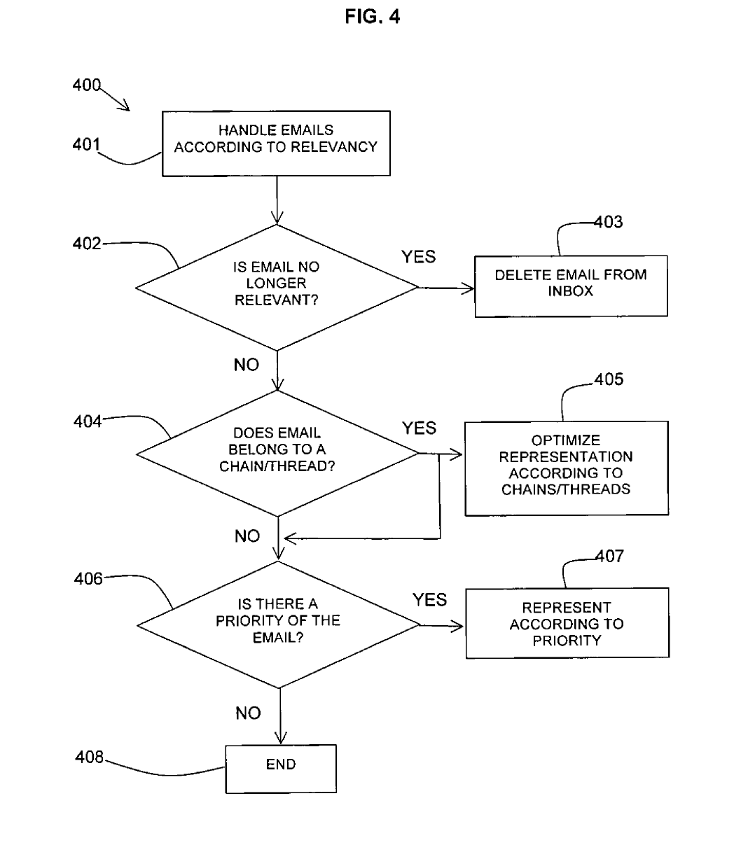

The emails may be handled 106 according to the relevancy feedback. Details of the handling are given in relation to FIG. 4. For example, if an email is indicated as no longer being relevant (for example, if it related to an event during the recipient's absence) then it can be removed from the user's inbox. As another example, email messages may be handled by having an optimized representation in the user's inbox, for example, according to a chain or thread of messages. A further example, is that the messages may be represented according to their priority, such as urgent, important, etc.

The user may see combined feedback from multiple senders who have replied to the feedback requests by a given time.

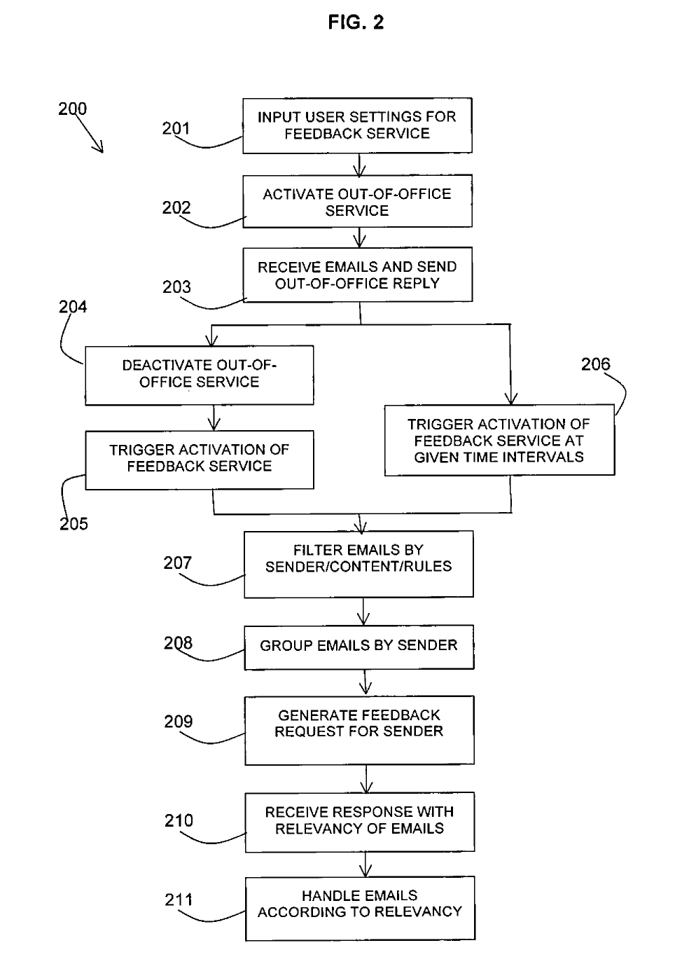

Referring to FIG. 2, a flow diagram 200 shows a first example embodiment of the described method. In this embodiment, the feedback service is applied to multiple emails collected at a user's inbox during a time period.

The time period may be the duration of an out-of-office service or a period within the out-of-office service. In this embodiment, the feedback service may be triggered after an out-of-office service has been in place for a recipient email user and is deactivated, or the feedback service may be provided at set time periods during the out-of-office service.

The user may therefore be present during the feedback service operation if it is after the out-of-office service is deactivated and may therefore personalize the feedback requests.

User settings may be input 201 for the feedback service, either as a preliminary step or during the following process.

An out-of-office service may be activated 202 for a user. Emails may be received or notification of emails may be received during the time period of the out-of-office service and automated out-of-office replies may be sent 203 to the senders of the emails.

In a first option, the out-of-office service may be deactivated 204 and the feedback service may be triggered 205. In a second option, the feedback service may be activated 206 at given time intervals or at given times during the out-of-office service. For example, at the end of each week, or more frequently in the case of very busy managers.

The received emails may be filtered 207 by sender, content or rules as described in relation to step 103 in FIG. 1.

In this embodiment, the feedback service may group 208 emails by sender in order to send a single feedback request to the sender relating to all the emails received from him during the time period.

A feedback request may be generated 209 for the sender. This may be personalized by a predefined user setting or at the time of sending if the user is available.

A response may be received 210 from the sender indicating the relevancy of the emails. The feedback service may then handle 211 the emails according to the relevancy.

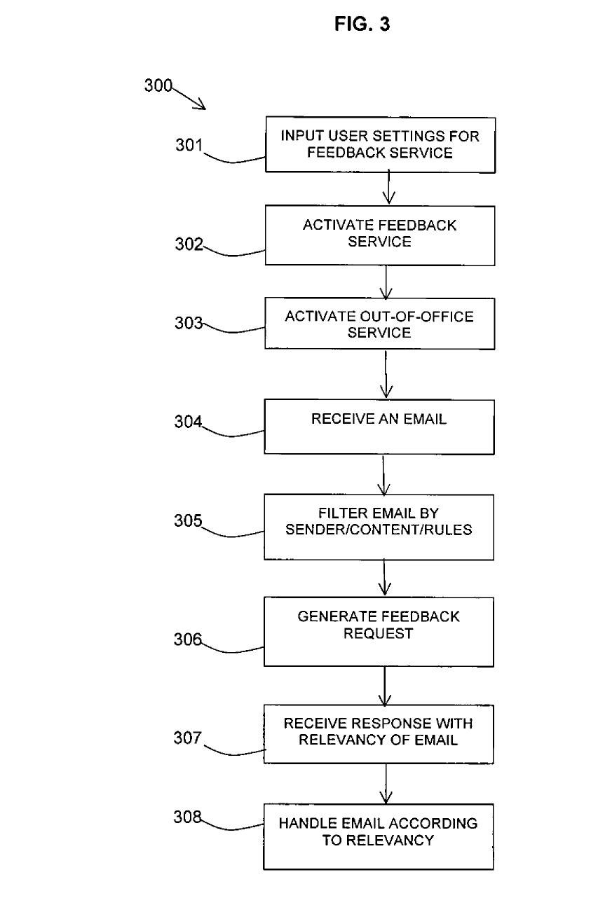

Referring to FIG. 3, a flow diagram 300 shows a second example embodiment of the described method. In this embodiment, the feedback service is applied to a single email as it arrives during an active feedback request session.

User settings may be input 301 and the feedback service activated 302. Optionally, an out-of-office service may be activated 303 or, alternatively, the feedback service itself may provide the out-or-office notification with the feedback request.

An email may be received 304. The email may be filtered 305 by sender/content/rules to determine if a feedback request is to be sent. If it is to be sent, the feedback request may be generated 306 with optional personalization provided by the user settings for the sender or as determined by defined rules.

A response may be received 307 to the feedback request from the sender specifying the relevancy of the email. The email may be handled 308 accordingly.

Referring to FIG. 4, a flow diagram 400 shows an example embodiment of how emails may be handled 401 once the feedback has been received from the sender. Other handling rules may be applied by a user.

In this embodiment, it may be determined 402 if the email is no longer relevant. If it is no longer relevant, it is deleted 403 from the user's inbox or moved to a separate inbox in case the user wishes to review such emails before permanently deleting them.

If it is still relevant, it may be determined 404 if the email belongs to a chain or thread. If so, the representation may be optimized 405 according to chains/threads.

If not, it may be determined 406 if there is a specified priority of the email. If so, the email may be represented according to its priority. For example, this may be done by highlighting urgent emails or placing them at the top of a list.

If there is no priority indicated, the method may end 408 or loop to the next email to be handled.

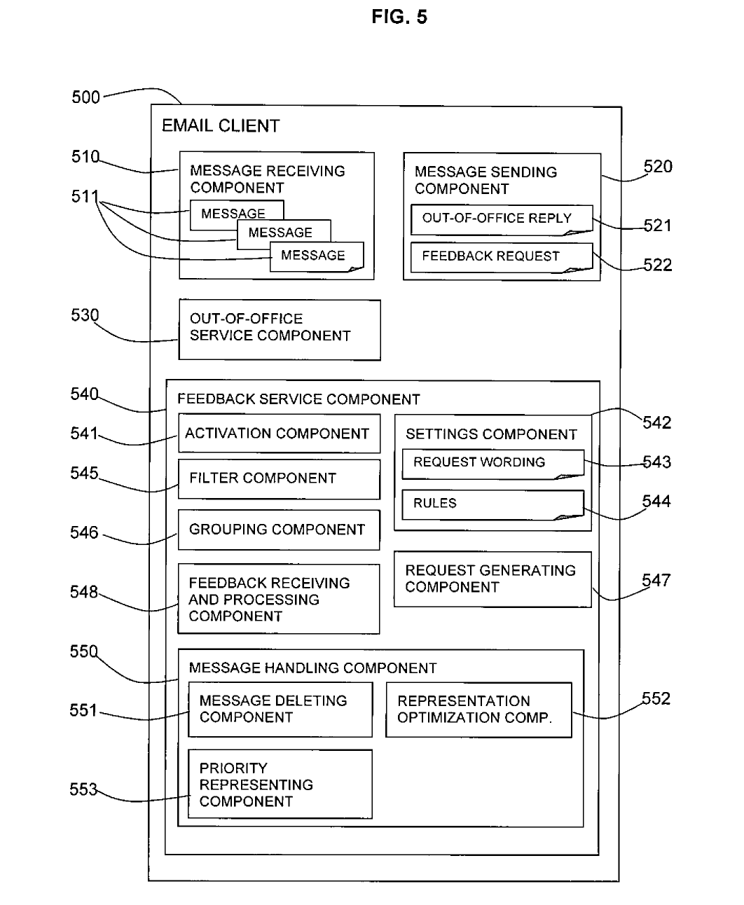

Referring to FIG. 5, a block diagram shows the described system provided in an email client 500 including the described feedback service function. The described feedback service function may be provided at an email client local to a user, or may be included in email server support at a remote server.

A message receiving component 510 may be provided in which incoming messages 511 are stored or referenced from another storage location. A message sending component 520 may be provided for sending outgoing messages, for example, an out-of-office reply message 521 and a feedback request message 522.

A feedback service component 540 is provided at the email client 500. An out-of-office service component 530 may also be provided at the email client 500; however, this is not essential to the operation of the feedback service component 540.

The feedback service component 540 may include a settings component 542 for user defined settings, such as rules 544 for activation, filtering, and message handling, and request wording 543.

The feedback service component 540 may include an activation component 541 for activating the service. The activation component 541 may be triggered by an event, such as end of an out-of-office service, or a time period as specified in the user settings.

The feedback service component 540 may include a filter component 545 for filtering emails by sender, content or rules to determine if a feedback request is to be sent.

The feedback service component 540 may also include a grouping component 546 for grouping emails according to the sender if the feedback service is applied to multiple emails.

A request generating component 547 may be provided linked to the feedback service component 540 for generating a request for feedback from a sender and sending the feedback request 522 as a message from the message sending component 520.

A feedback receiving and processing component 548 may be provided which in cooperation with a message handling component 550 determines or analyzes the content of the feedback response and handles the emails accordingly. The message handling component 550 may include a message deleting component 551 for deleting messages 511 from the message receiving component 510 which are indicated as no longer being relevant in the feedback. A representation optimization component 552 may be provided for optimizing the representation of messages 511 in the message receiving component 510 by grouping chains/threads of messages. A priority representing component 553 may also be provided for representing the priority of messages 511 in the message receiving component 510 according to the feedback received.

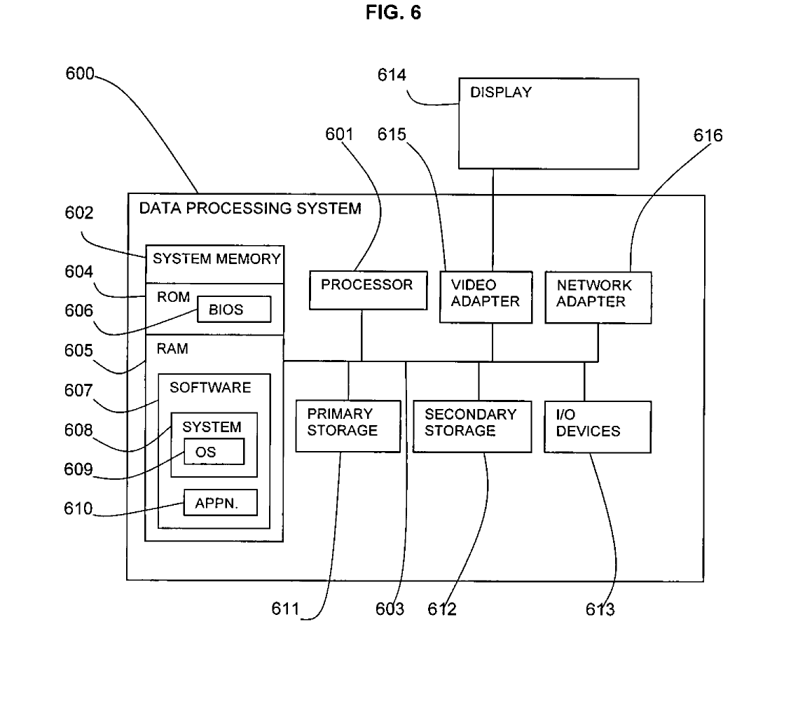

Referring to FIG. 6, an exemplary system for implementing aspects of the invention includes a data processing system 600 suitable for storing and/or executing program code including at least one processor 601 coupled directly or indirectly to memory elements through a bus system 603. The memory elements can include local memory employed during actual execution of the program code, bulk storage, and cache memories which provide temporary storage of at least some program code in order to reduce the number of times code must be retrieved from bulk storage during execution.

The memory elements may include system memory 602 in the form of read only memory (ROM) 604 and random access memory (RAM) 605. A basic input/output system (BIOS) 606 may be stored in ROM 604. System software 607 may be stored in RAM 605 including operating system software 608. Software applications 610 may also be stored in RAM 605.

The system 600 may also include a primary storage means 611 such as a magnetic hard disk drive and secondary storage means 612 such as a magnetic disc drive and an optical disc drive. The drives and their associated computer-readable media provide non-volatile storage of computer-executable instructions, data structures, program modules and other data for the system 600. Software applications may be stored on the primary and secondary storage means 611, 612 as well as the system memory 602.

The computing system 600 may operate in a networked environment using logical connections to one or more remote computers via a network adapter 616.

Input/output devices 613 can be coupled to the system either directly or through intervening I/O controllers. A user may enter commands and information into the system 600 through input devices such as a keyboard, pointing device, or other input devices (for example, microphone, joy stick, game pad, satellite dish, scanner, or the like). Output devices may include speakers, printers, etc. A display device 614 is also connected to system bus 603 via an interface, such as video adapter 615.

Key personnel and managers may particularly benefit from such a service in order to help prioritize their workload, particularly after a period of absence. Employees may formulate a polite suggestion to go over a list of sent emails.

### Example

A personalized feedback request may include the following example message:

Hi Bob, I'm back from my Holland trip. Missed you, chocolates in
my room.
I'll try to go over your correspondence ASAP, however you are
welcome to highlight urgent mail:

| Urgent | Irrelevant | Mail | Date/Time Sent |
|---|---|---|---|
| [ ] | [v] | Coffee break? | 05/11/11 10.00 |
| [v] | [ ] | Presentation for the alpha client | 05/13/11 08.00 |
| [ ] | [ ] | New topic tutorial | 05/13/11 16.00 |
| [ ] | [v] | Today team meeting at 6, updated | 05/15/11 10.30 |
| | | info | |

A feedback service system may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for sender feedback on email correspondence performed by a computerized device, comprising:
activating a feedback service;
receiving notification of one or more emails;
generating a feedback request to an email sender;
receiving a response to the feedback request providing feedback; and
handling an email in accordance with the received feedback.

2. The method as claimed in claim 1, including:
filtering received emails to determine if a feedback request is to be sent,
wherein the filtering is based on one of the group of: the sender, the email content, defined rules, and history.

3. The method as claimed in claim 2, wherein filtering received emails based on the sender filters by one of the group of: an enterprise hierarchy, user rules, manual exclusion, history, or social network relationship.

4. The method as claimed in claim 1, wherein if the feedback indicates that an email is no longer relevant, the handling step includes deleting or marking the email accordingly.

5. The method as claimed in claim 1, wherein the feedback includes a priority of an email, and the handling step includes representing the email according to the priority.

6. The method as claimed in claim 1, including:
receiving notification of multiple emails;
grouping the emails by sender; and
generating a feedback request to a sender relating to all emails received from the sender.

7. The method as claimed in claim 1, including:
automatically activating the feedback service after deactivation of an out-of-office service; and
generating feedback requests for emails received whilst the out-of-office service was active.

8. The method as claimed in claim 7, wherein generating feedback requests is carried out at a predefined time before a user is scheduled to return to the office.

9. The method as claimed in claim 1, including:
automatically activating the feedback service during an out-of-office service; and
generating feedback requests for emails received during defined time periods or for each email received.

10. The method as claimed in claim 1, including:
automatically activating the feedback service when a number of unread emails reaches a predefined threshold.

11. The method as claimed in claim 1, including:
manually activating the feedback service by a user for a group of emails.

12. The method as claimed in claim 1, including:
personalizing the feedback request to be sent to all or specific senders according to user settings.

13. The method as claimed in claim 1, wherein the feedback request includes a list of emails and checkboxes to indicate relevance and/or priority.

14. The method as claimed in claim 12, wherein the feedback request presentation of the list of emails is optimized by combining emails of the same chain or subject.

15. A computer program product for sender feedback on email correspondence, the computer program product comprising:
a computer readable non-transitory storage medium having computer readable program code embodied therewith, the computer readable program code comprising:
computer readable program code configured to:
activate a feedback service;
receive notification of one or more emails;
generate a feedback request to an email sender;
receive a response to the feedback request providing feedback; and
handle an email in accordance with the received feedback.

16. A system for sender feedback on email correspondence provided at an email client or an email server, comprising:
a processor;
a message receiving component for receiving emails or receiving notification of emails held at another location;
a feedback service component including:
an activation component for activating a feedback service;
a request generating component for generating a feedback request to an email sender;
a feedback receiving and processing component for receiving a response to the feedback request providing feedback; and
a message handling component for handling an email in accordance with the received feedback.

17. The system as claimed in claim 16, wherein the feedback service component includes:
a filter component for filtering received emails to determine if a feedback request is to be sent,
wherein the filtering is based on one of the group of: the sender, the email content, defined rules, and history.

18. The system as claimed in claim 16, wherein the message handling component includes:
a message deleting component for deleting an email from the message receiving component if the feedback indicates that an email is no longer relevant.

19. The system as claimed in claim 16, wherein the message handling component includes:
a priority representing component for representing the email according to the priority.

20. The system as claimed in claim 16, wherein the feedback service component includes:
a grouping component for grouping emails by sender; and
wherein the request generating component generates a feedback request to a sender relating to all emails received from the sender.

21. The system as claimed in claim 16, wherein the activation component is for activating the feedback service after the deactivation of an out-of-office service; and the request generating component generates feedback requests for emails received whilst the out-of-office service was active.

22. The system as claimed in claim 16, wherein the activation component is for activating the feedback service during an out-of-office service; and the request generating component generates feedback requests for emails received during defined time periods or for each email received.

23. The system as claimed in claim 16, wherein the feedback service component includes:
a settings component for personalizing the feedback request to be sent to all or specific senders according to user settings.

24. A method of providing a feedback service for email correspondence to a customer over a network, the service comprising:
activating a feedback service;
receiving one or more emails;
generating a feedback request to an email sender;
receiving a response to the feedback request providing feedback; and
handling an email in accordance with the received feedback.
